(19) United States
(12) Patent Application Publication
(10) Pub. No.: US 2015/0291327 A1
(43) Pub. Date: Oct. 15, 2015

(54) THERMALLY PROTECTIVE COVER AND METHOD OF MANUFACTURE THEREOF

(71) Applicant: E.II. DU PONT DE NEMOURS AND COMPAANY, Wilmington, DE (US)

(72) Inventors: Srinivas Cherukupalli, Hyderabad (IN); Atanu Acharya, Secunderabad (IN); Raghvendra Singh Pal, Lucknow (IN)

(21) Appl. No.: 14/646,580

(22) PCT Filed: Nov. 22, 2013
(86) PCT No.: PCT/US13/71506

§ 371 Date: May 21, 2015

(30) Foreign Application Priority Data
Nov. 22, 2012 (IN) 3583/DEL/2012

(51) Int. Cl. B65D 65/40; B32B 5/18; B32B 15/20; B32B 3/26; B32B 15/14; B32B 5/02; B32B 5/24

(52) U.S. Cl. CPC B65D 65/40; B32B 5/022; B32B 5/18; B32B 5/245; B32B 3/266; B32B 15/14; B32B 15/20; B32B 2255/02; B32B 2266/0207; B32B 2262/0253; B32B 2307/304; B32B 2439/70; B32B 2439/80

(57) ABSTRACT

A multilayered thermally protective cover is provided for storage and transportation of temperature sensitive materials. The cover has an outer surface and an inner surface relative to the material and contains layers such that an outer layer adjacent to the outer surface is a plexifilamentary web, an inner layer adjacent to the inner surface is a nonwoven web, an internal layer or layers located between the outer and inner layers contains a closed cell polymeric foam and wherein the protective cover is impermeable to air.

### FIELD OF THE INVENTION

The present invention relates to thermally protective cover for storage or transportation of temperature sensitive material which is to be maintained at or near their temperature at the time of packaging.

This invention also relates to a method of manufacture of thermal barriers for transport and storage of articles having improved thermal protection properties for temperature sensitive materials.

### BACKGROUND OF THE INVENTION

Conventional means of shipping temperature sensitive materials such as pharma and bio-pharma products involve the use of an insulated box along with some cooling agent. These cooling agents are typically a frozen gel, dry ice, or glistening (wet) ice. There are, however, several problems with the conventional approach.

First, the insulation material often does not degrade readily, leading to disposal problems. Styofoam® is one of the commonly used insulation material. These problems are so severe that many countries ban the use of Styrofoam®, thus severely restricting international shipments of biological materials.

Second, the cooling agents also present numerous practical problems in field use. Specifically, gel systems are often too expensive for routine use and disposal. As for dry ice, the carbon dioxide gas evolved during shipment may be dangerous to personnel involved with packing and transportation of the shipment. Wet ice poses handling problems in packing, as well as leakage and product soaking problems.

Many previously existing shipping systems also suffer the disadvantage that they are not capable of maintaining the shipped product or payload within a target temperature range. Various biological products, such as platelets, whole blood, semen, organs and tissue, must be maintained above a predetermined minimum temperature and below a predetermined maximum temperature. Pharmaceutical products are also commonly required to be kept within a specified temperature range. Food products, flowers and produce frequently have preferred storage temperature ranges as well. Many known methods and systems for shipping such products are not able to keep temperatures within the desired range. The result of this practice is excessive cooling, frequently resulting in damage to the product.

Previously known methods and systems which are capable of maintaining a payload within a specified temperature range have been found to be unsuited to certain applications, unduly complex in practice, and/or prohibitively expensive.

Another problem often observed with conventional systems is failure to maintain the proper temperature over time, due to inadequate insulation and/or inadequate cooling pack capacity. Again, the end result is product damage.

The consequence of these observed shortcomings of conventional shipping systems is damage to the material being transported. For biomedical materials such as blood, blood products, pharmaceuticals, etc., loss of these products due to heat damage is critical because of the intrinsic financial value of these items and because of the potential health hazards that the use of compromised materials presents. Likewise, heat damage to various foods also presents both financial and health consequences.

Vaccines and serums are expected to be maintained, in most cases, between 2-8° C. for 48-100 hours (depending on destination) during shipment through air or road. This requirement is typically achieved by using a Styrofoam® box filled with adequate gel packs to maintain the required product temperature. However, with increasing exposure to ambient conditions, the gel pack efficiency decreases and thereby puts the product at risk of losing potency.

Therefore, there is a need to have thermal protective cover which significantly increases the time at which the product stays between a required temperature range and which is easy to manufacture, use and is also more cost effective. This would result in better protection for temperature sensitive products with more economical solutions for transporting and preserving them.

### OBJECTS OF THE INVENTION

An object of the present invention is to provide a thermal protection cover having improved air permeability to protect pharma/bio pharma products or other such temperature sensitive materials from temperature excursions primarily during shipment or transportation.

### SUMMARY OF THE INVENTION

This invention provides a thermal protection cover having improved air permeability to protect pharma/bio pharma products or other such temperature sensitive materials from temperature excursions during shipment primarily during shipment or transportation.

In one embodiment the invention is directed to a multilayered thermally protective cover for protecting temperature sensitive material. The cover has an outer surface and an inner surface relative to the material and comprises a plurality of layers such that;
an outer layer adjacent to the outer surface is a plexifilamentary web comprising a multiplicity of fibers,
an inner layer adjacent to the inner surface is a nonwoven web,
an internal layer or layers located between the outer and inner layers comprises closed cell polymeric foam; and
wherein the protective cover is impermeable to air.

In a further embodiment the cover further comprises a layer of connected vacuum panels, each panel having a porous core layer enveloped in a skin layer and at least partially evacuated, and having a metal foil covering that completely envelops the skin layer.

### BRIEF DESCRIPTION OF THE DRAWINGS

FIG. 1 is a sectional view of the thermal protection cover of a first embodiment of the present invention:

FIG. 2 is a sectional view of the thermal protection cover of a second embodiment of the present invention:

FIG. 3 is a sectional view of a vacuum insulation panel:

FIG. 4 is a data logger chart comparing temperature profiles for maximum ambient temperature of 40° C.

FIG. 5 is a data logger chart comparing temperature profiles for average exposure temperature of 33° C. in the absence of sunlight.

FIG. 6 is a data logger chart comparing temperature profiles for maximum ambient temperature of 37° C.

FIG. 7 is a data logger chart comparing temperature profiles for maximum exposure temperature of 32° C. in direct sunlight.

FIG. 8 is a data logger chart comparing temperature profiles for average exposure temperature of 25° C. in direct sunlight.

FIG. 9 is a data logger chart comparing temperature profiles for exposure in direct sunlight.

FIG. 10 is a data logger chart comparing temperature profiles for exposure in direct sunlight.

### DETAILED DESCRIPTION OF THE INVENTION

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The term “polymer” as used herein, generally includes but is not limited to, homopolymers, copolymers (such as for example, block, graft, random and alternating copolymers), terpolymers, etc., and blends and modifications thereof. Furthermore, unless otherwise specifically limited, the term “polymer” shall include all possible geometrical configurations of the material. These configurations include, but are not limited to isotactic, syndiotactic, and random symmetries.

The term “polyolefin” as used herein, is intended to mean any of a series of largely saturated polymeric hydrocarbons composed only of carbon and hydrogen. Typical polyolefins include, but are not limited to, polyethylene, polypropylene, polymethylpentene, and various combinations of the monomers ethylene, propylene, and methylpentene.

The term “polyethylene” as used herein is intended to encompass not only homopolymers of ethylene, but also copolymers wherein at least 85% of the recurring units are ethylene units such as copolymers of ethylene and alpha-olefins. Preferred polyethylenes include low-density polyethylene, linear low-density polyethylene, and high-density polyethylene. A preferred high-density polyethylene has an upper limit melting range of about 130° C. to 140° C., a density in the range of about 0.941 to 0.980 gram per cubic centimeter, and a melt index (as defined by ASTM D-1238-57T Condition E) of between 0.1 and 100, and preferably less than 4.

The term “polypropylene” as used herein is intended to embrace not only homopolymers of propylene but also copolymers where at least 85% of the recurring units are propylene units. Preferred polypropylene polymers include isotactic polypropylene and syndiotactic polypropylene.

The term “plexifilament” as used herein means a three-dimensional integral network or web of a multitude of thin, ribbon-like, film-fibril elements of random length. Typically, these have a mean film thickness of less than about 4 micrometers and a median fibril width of less than about 25 micrometers. The average film-fibril cross sectional area if mathematically converted to a circular area would yield an effective diameter between about 1 micrometer and 25 micrometers. In plexifilamentary structures, the film-fibril elements intermittently unite and separate at irregular intervals in various places throughout the length, width and thickness of the structure to form a continuous three-dimensional network. Examples of plexifilamentary webs are those produced by the processes described in U.S. Pat. No. 3,081,519 (Blades et al.), U.S. Pat. No. 3,169,899 (Steuber), U.S. Pat. No. 3,227,784 (Blades et al.), U.S. Pat. No. 3,851,023 (Brethauer et al.), the contents of which are hereby incorporated by reference in their entirety. Examples of commercially available plexifilamentary webs are the sheets supplied by the DuPont Company of Wilmington, Del. under the name Tyvek®.

The term “nonwoven” means a web including a multitude of randomly distributed fibers. The fibers generally can be bonded to each other or can be unbonded. The fibers can be staple fibers or continuous fibers. The fibers can comprise a single material or a multitude of materials, either as a combination of different fibers or as a combination of similar fibers each comprised of different materials.

An as-spun nonwoven of the present invention can be consolidated by processes known in the art (e.g. calendering) in order to impart the desired improvements in physical properties. The term “consolidated” generally means that the nonwoven has been through a process in which it is compressed and its overall porosity has been reduced. In one embodiment of the invention the as-spun nonwoven is fed into the nip between two unpatterned rolls in which one roll is an unpatterned soft roll and one roll is an unpatterned hard roll. The temperature of one or both rolls, the composition and hardness of the rolls, and the pressure applied to the nonwoven can be varied to yield the desire end use properties. In one embodiment of the invention, one roll is a hard metal, such as stainless steel, and the other a soft-metal or polymer-coated roll or a composite roll having a hardness less than Rockwell B 70. The residence time of the web in the nip between the two rolls is controlled by the line speed of the web, preferably between about 1 m/min and about 50 m/min, and the footprint between the two rolls is the machine direction (MD) distance that the web travels in contact with both rolls simultaneously. The footprint is controlled by the pressure exerted at the nip between the two rolls and is measured generally in force per linear cross-direction (CD) dimension of roll, and is preferably between about 1 mm and about 30 mm.

Further, the nonwoven web can be stretched, optionally while being heated to a temperature that is between the glass-transition temperature (T_{g}) and the lowest onset-of-melting temperature (Tₒₘ) of the fiber polymer. The stretching can take place either before and/or after the web passes through the calender roll nip, and in either or both of the MD or CD.

The term “continuous” when applied to fibers means that the fibers have been laid down during the manufacture of a nonwoven structure in one continuous stream, as opposed to being broken or chopped.

“Meltblown fibers” are fibers formed by extruding a molten thermoplastic material through a plurality of fine, usually circular, die capillaries as molten threads or filaments into converging, usually hot and high velocity, gas, e.g. air, streams to attenuate the filaments of molten thermoplastic material and form fibers. During the melt blowing process, the diameter of the molten filaments is reduced by the drawing air to a desired size. Thereafter, the melt blown fibers are carried by the high velocity gas stream and are deposited on a collecting surface to form a web of randomly disbursed melt blown fibers. Such a process is disclosed, for example, in U.S. Pat. No. 3,849,241 to Buntin et al., U.S. Pat. No. 4,526,733 to Lau, and U.S. Pat. No. 5,160,746 to Dodge, I I et al., all of which are hereby incorporated herein by this reference. Meltblown fibers may be continuous or discontinuous.

As used herein the term “spunbond fibers” refers to small diameter fibers which are formed by extruding molten thermoplastic material as filaments from a plurality of fine, usually circular capillaries of a spinnerette with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763, and U.S. Pat. No. 3,542,615 to Dobo et al. Spunbond fibers are generally continuous and larger than 7 microns, more particularly, they are usually between about 15 and 50 microns.

Spunbond and melt blown fibers can be laminated together, for example into spunbond-meltblown-spunbond structures, designated here as “SMS.” The SMS structures can also be calendered.

For purposes of describing the features of the laminate described herein,
the term “thermally protective” cover refers to an article which aids in protecting against thermal excursions of a product or the material to be thermally protected or transported;
the term “radiative barrier” refers to materials which allows for an efficient reflectivity of solar radiation;
the term “insulation layer” refers to a structure designed to reduce or minimize heat transfer there through;
the term “air permeability” refers to the time required for specific volume of air under unit pressure to pass through unit area, as measured by standard Gurley method and expressed as seconds per 100 cc of air;
“reflectivity” refers to the ability to reflect electromagnetic radiation;
“emissivity” refers to the ability of a material to re-emit absorbed thermal energy as radiation;
“R-value” is defined as the thermal resistivity of a material as measured by a guarded hot plate instrument;
“reduced atmospheric pressure” refers to a condition of lowered concentration of air within a confined space as compared to atmospheric pressure.

“Gurley method” is based on the principle that air is compressed by the weight of a vertical cylinder floating in a liquid. A test piece is in contact with the compressed air and the cylinder falls steadily as air passes through the test piece. The time for a given volume of air to pass through the test piece, i.e. the air resistance is measured and from this the air permeability is calculated.

One aspect of this invention is a multilayered thermally protective cover for protecting temperature sensitive material, said cover having an outer surface and an inner surface relative to the material and comprising a plurality of layers such that;
an outer layer adjacent to the outer surface is a plexifilamentary web comprising a multiplicity of fibers,
an inner layer adjacent to the inner surface is a nonwoven web,
an internal layer or layers located between the outer and inner layers comprises closed cell polymeric foam;
wherein the protective cover is impermeable to air.

In another embodiment of the present invention, the multilayered thermally protective cover further comprises a layer of connected vacuum panels, each panel having a porous core layer enveloped in a skin layer and at least partially evacuated, and having a metal foil covering that completely envelops the skin layer.

In another embodiment of the present invention, the nonwoven web is a spunbond nonwoven of polyolefin.

In another embodiment of the present invention, the polyolefin is a polyethylene, polypropylene, polybutene, or a blend or copolymer thereof.

In yet another embodiment of the present invention, the plexifilamentary web is preferably a flash spun polyolefin web.

In another embodiment of the present invention, the multilayered thermally protective cover further comprises a radiative barrier layer located between the nonwoven layer and the foam layer.

In another embodiment of the present invention, the multilayered thermally protective cover further comprises a radiative barrier coating on at least a portion of the fibers of the plexifilamentary web.

In another embodiment of the present invention, the plexifilamentary web has a reflectivity of at least 50% in the wavelength region of 400-700 nm.

In another embodiment of the present invention, the radiative barrier layer has a reflectivity of at least 20% in the wavelength region of 100-3000 nm and an emissivity of at least 0.05.

In another embodiment of the present invention, the radiative barrier layer is selected from a group consisting of metal foils, nonwovens, microporous membranes, perforated sheets, porous cellulosic sheets or combinations thereof.

In another embodiment of the present invention, the foam layer has an R-value of 0.1-13 m2K/W.

In another embodiment of the present invention, the foam layer is selected from the group consisting of nitrile rubber foam, nitrile rubber blended with polyvinyl chloride foam, crosslinked polyethylene foam, polyurethane foam, polystyrene foam, water filled super absorbent polymer or combinations thereof.

Turning to the figures:

FIG. 1 is a sectional view of the thermal protection cover of a first embodiment of the present invention:
1. Flash spun polyolefin (Tyvek® 1048A)
2. Closed cell foam
3. Spun bond polypropylene
4. Corrugated box containing temperature sensitive material (not shown)

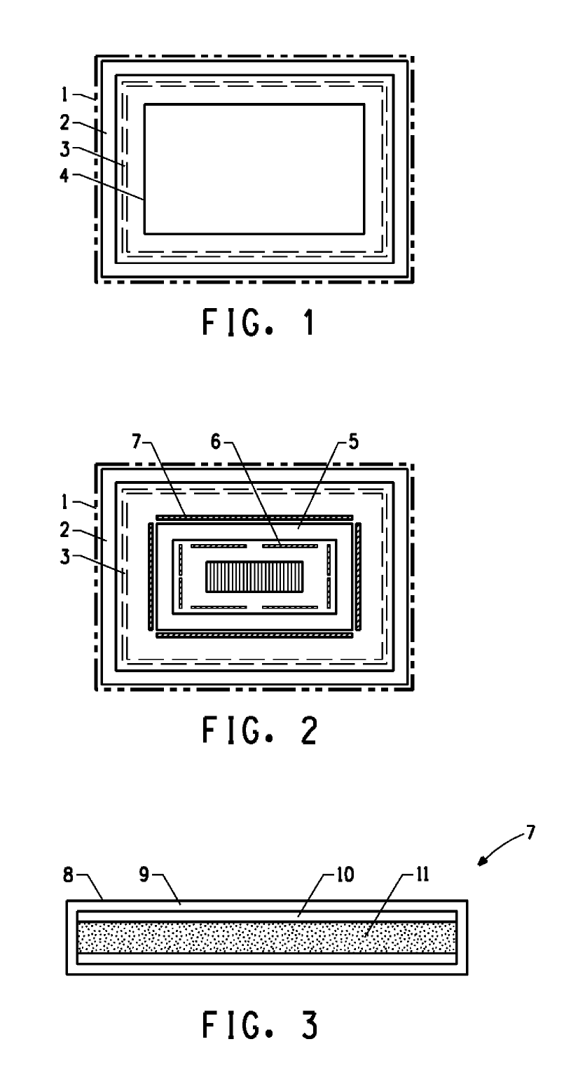

FIG. 2 is a sectional view of the thermal protection cover of a second embodiment of the present invention:
1. Flash spun polyolefin (Tyvek® 1048A)
2. Closed cell foam
3. Spun bond polypropylene
4. Corrugated box containing temperature sensitive material (not shown)
5. Styrofoam box with 1-inch wall thickness
6. Gel packs
7. 8 mm vacuum insulation panel enclosed in laminated Aluminum foil

FIG. 3 is a sectional view of the vacuum insulation panel:
8. Outer polymeric laminating film
9. Aluminum foil
10. Inner polymeric laminating film
11. Porous powder

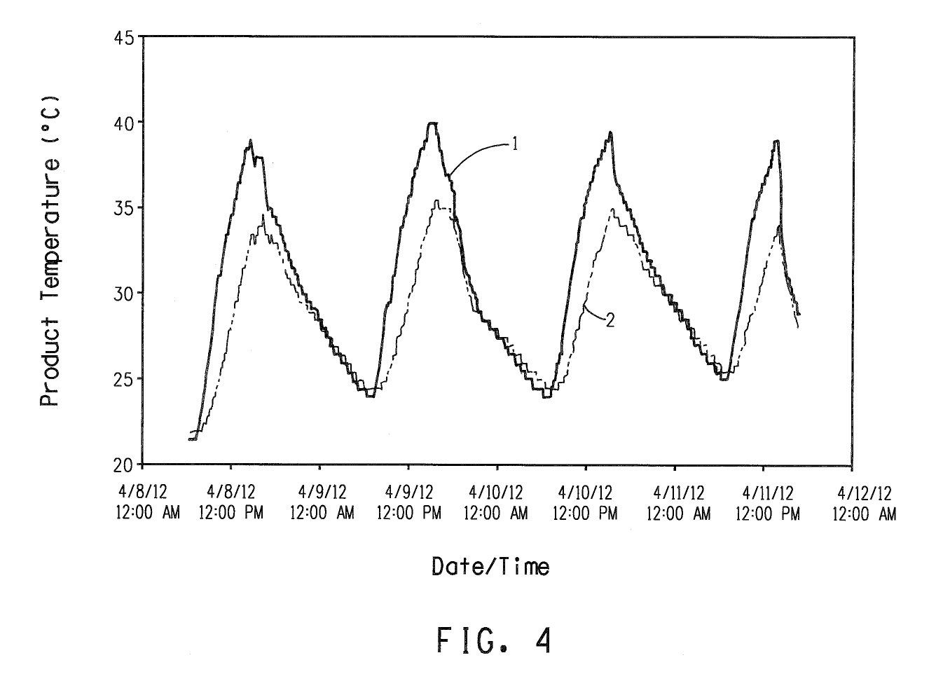

FIG. 4 is a data logger chart comparing temperature profiles for maximum ambient temperature of 40° C.
1. Temperature profile for Tyvek® 1048A cover
2. Temperature profile for stitched cover comprising Tyvek® 1048A, 6 mm nitrile rubber closed cell insulation, and spun bond polypropylene

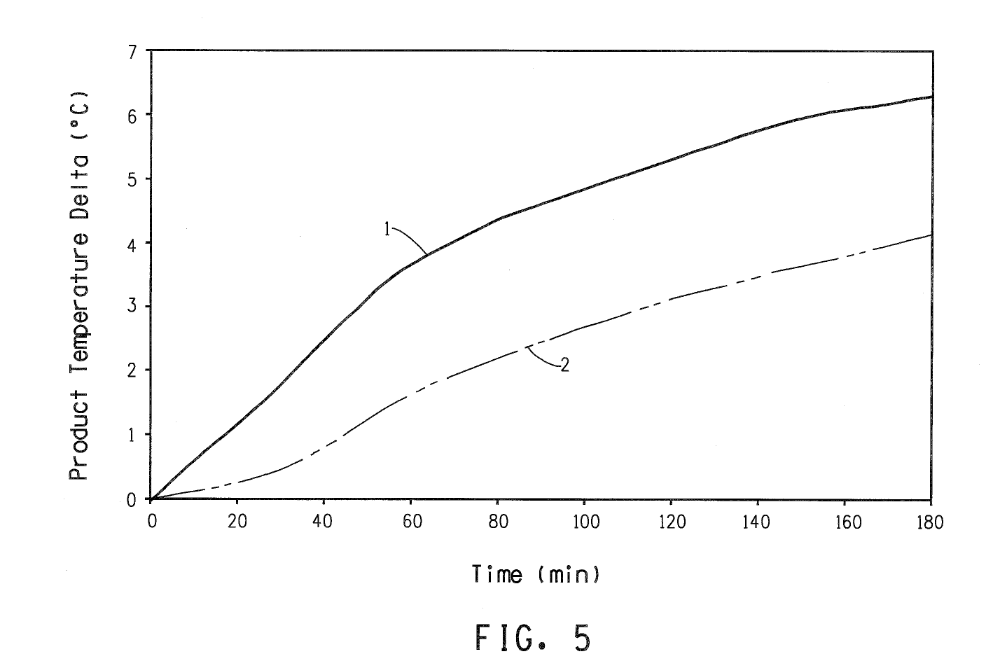

FIG. 5 is a data logger chart comparing temperature profiles for average exposure temperature of 33° C. in the absence of sunlight.
1. Temperature profile for Tyvek® 1048A cover
2. Temperature profile for stitched cover comprising of Tyvek® 1048A, 6 mm nitrile rubber closed cell insulation, and spun bond polypropylene

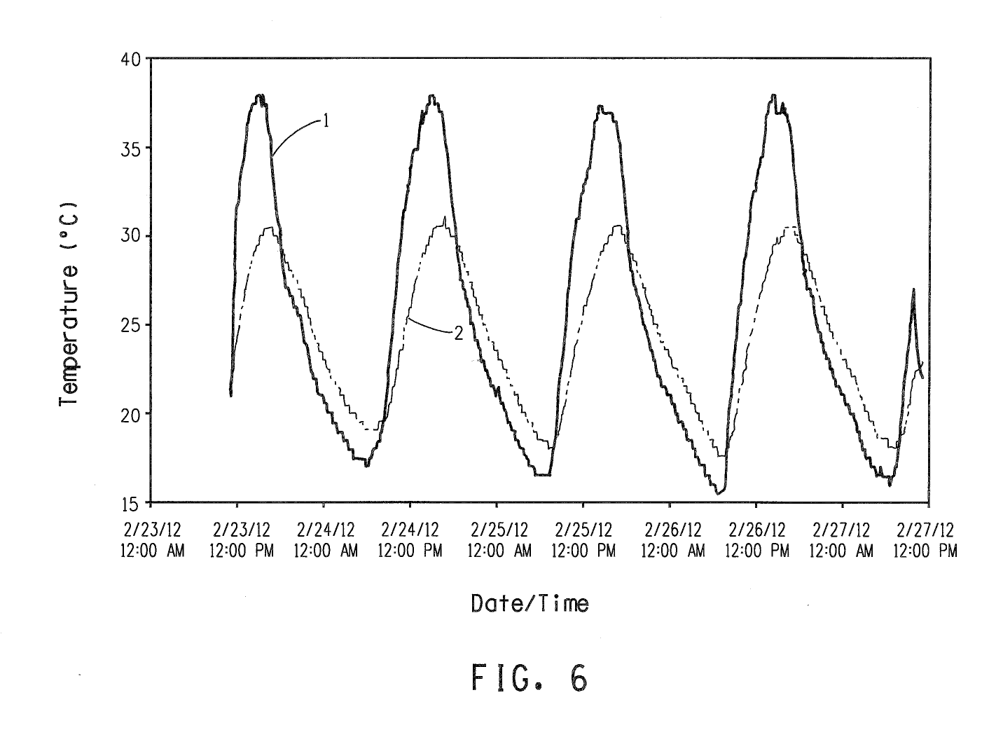

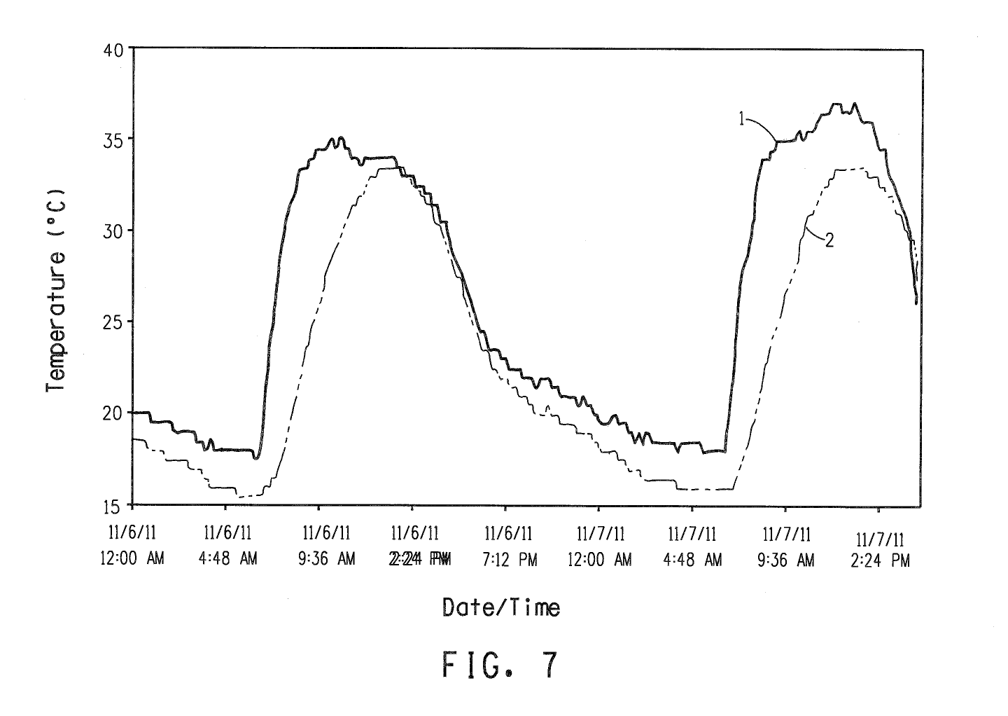

FIG. 6 is a data logger chart comparing temperature profiles for maximum ambient temperature of 37° C.
1. Temperature profile for Tyvek® 1048A cover
2. Temperature profile for stitched cover comprising of Tyvek® 3563M, 9 mm nitrile rubber closed cell insulation, and spun bond polypropylene

FIG. 7 is a data logger chart comparing temperature profiles for maximum exposure temperature of 32° C. in direct sunlight.
1. Temperature profile for Tyvek® 1048A cover
2. Temperature profile for cover comprising of Tyvek® 1048A and laminated super absorbent polymer

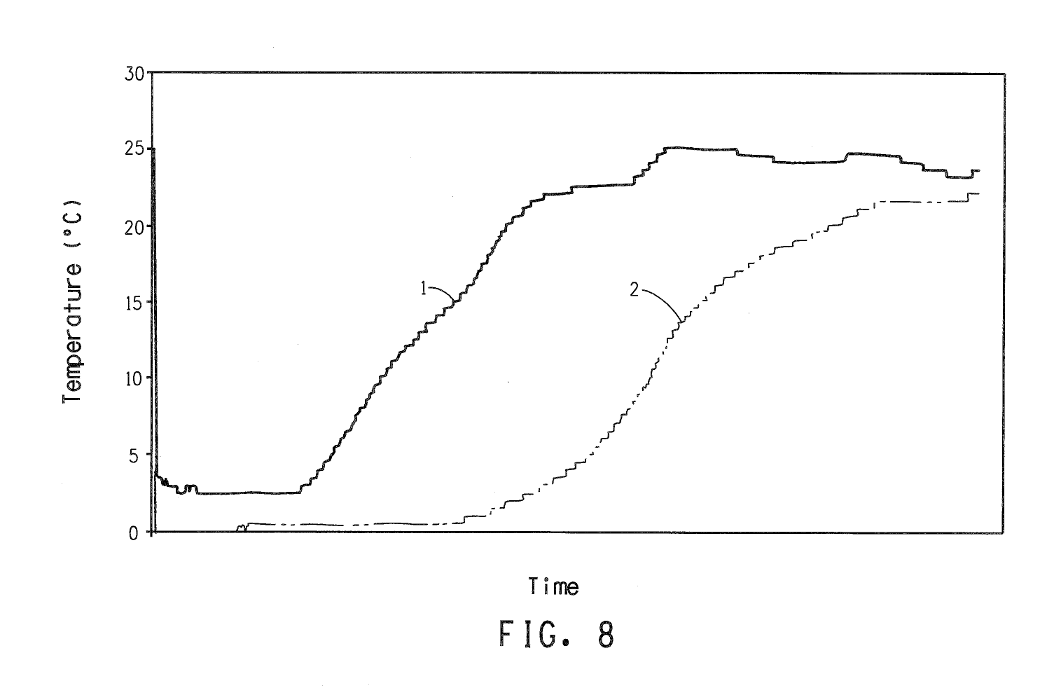

FIG. 8 is a data logger chart comparing temperature profiles for average exposure temperature of 25° C. in direct sunlight.
1. Temperature profile for Styrofoam box filled with gel packs and product.
2. Temperature profile for stitched cover comprising of Tyvek® 1048A, 6 mm nitrile rubber closed cell insulation, and spun bond polypropylene. Vacuum insulation panels made using honey comb structures are placed as an additional protection layer after the stitched cover. These layers enclose a Styrofoam box filled with gel packs and product.

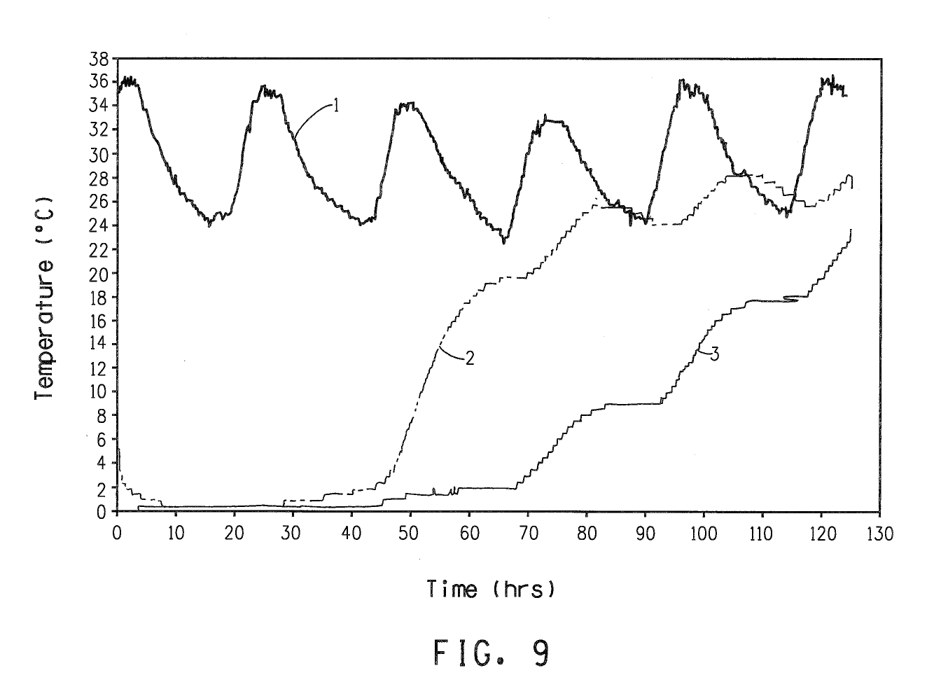

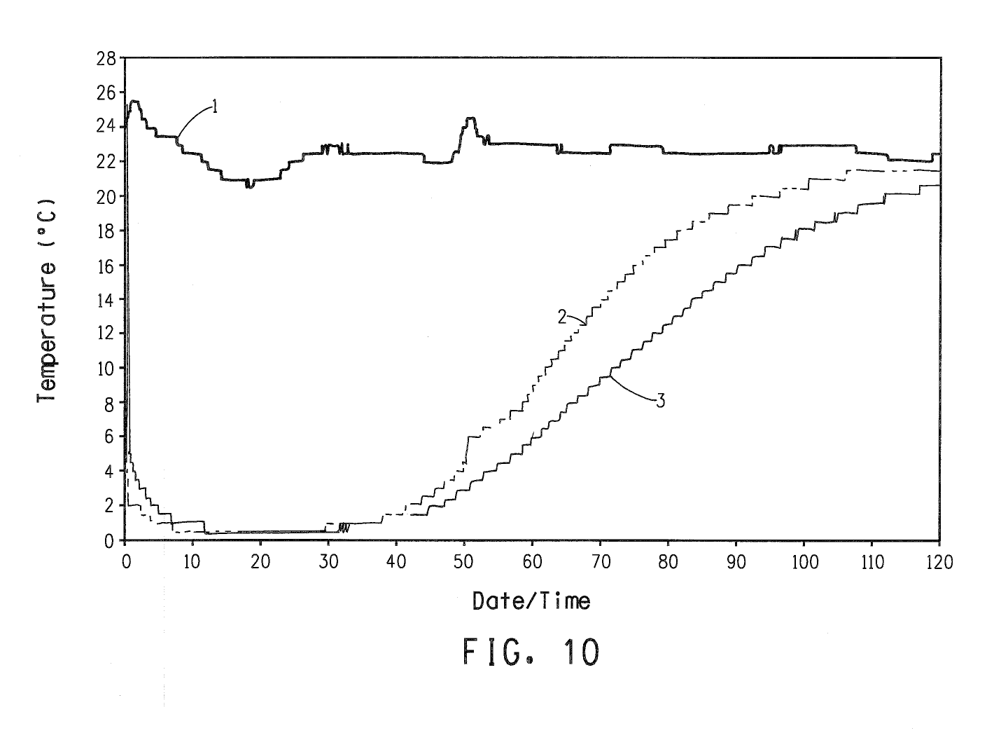

FIG. 9 is a data logger chart comparing temperature profiles for exposure in direct sunlight.
1. Ambient temperature
2. Temperature profile for Styrofoam box filled with gel packs and product.
3. Temperature profile for stitched cover comprising of Tyvek® 1048A, 6 mm nitrile rubber closed cell insulation, and spun bond polypropylene. 8 mm vacuum insulation panels made using fumed silica are placed as an additional protection layer after the stitched cover. These layers enclose a Styrofoam box filled with gel packs and product.

FIG. 10 is a data logger chart comparing temperature profiles for exposure in direct sunlight.
1. Ambient temperature
2. Temperature profile for Styrofoam box filled with gel packs and product.
3. Temperature profile for stitched cover comprising of Tyvek® 1048A, 6 mm nitrile rubber closed cell insulation, and spun bond polypropylene. 8 mm vacuum insulation panels made using fumed silica are placed as an additional protection layer after the stitched cover. These layers enclose a wooden box filled with gel packs and product.

### EXAMPLES

Following materials were used as barrier layers in the thermal protective cover of this invention:

Tyvek® 1048A—a flash spun non-woven high density polyethylene from E.I. DuPont de Nemours Company, Wilmington, Del.

Tyvek® 3563M—a breathable, metalized flash spun non-woven high density polyethylene made by the process of vapor deposition available from E.I. DuPont de Nemours Company, Wilmington, Del.

Closed cell Nitrile Rubber foam (blended with about 40 wt % Poly vinyl chloride);

Metallised Tyvek® with 9 mm closed cell Nitrile Rubber foam, in combination with certain convective, conductive and insulation materials.

U-Vacua vacuum insulation panel available from Panasonic®, Japan

Paper honeycomb structure of 12″ width, 15 mm height, and wall thickness of 2 mm available from Honecore™, Bangalore

Type 142/52/10 super absorbent polymer of 140 g/m2 basis weight as available from Technical Absorbent, UK

Following methods were used for testing properties of the thermal protective cover of this invention:

Air permeability of a pallet cover was measured by an ISO 5636-5 method using a Gurley 4340 apparatus. The apparatus consisted of an opening for a flat-sheet sample to be inserted and clamped pneumatically. Upon clamping, a constant volume of air is passed through the test specimen at a particular applied pressure (specified by Gurley 4340 automatic densometer provided by Gurley Precision Instruments, Troy, N.Y., USA) and the time taken (in seconds) is displayed by the instrument to indicate the air permeability of the sample.

Average peak temperatures of pallets prepared in the below examples was measured using a iButton DS1921G-F5 data logger which can record air temperature for every 10 minutes with an accuracy of ±0.5° C.

Thermal resistance of layers was measured as per ASTM C518 using a Netzsch HFM 436/3 Lambda Heat Flow Meter. The sample size used was 30 cm×30 cm with a thickness of at least 5 mm.

### Example 1

A 750×750×750 mm³ pallet was prepared with 27 corrugated packaging boxes of 3-ply construction and enclosed with a cover of the following layers stitched together (from outside in)—Tyvek® 1048A, 6 mm nitrile rubber foam, and an inner layer of spun bonded Polypropylene (100 g/m² basis weight). The cover showed an air permeability value of 13545 s per 100 cc of air as measured by Gurley method and had a thermal resistance of 0.209 m²K/W as measured using a heat flow meter at 24° C.

Data logger was placed in top row corner box with 1.7 kgs of gel packs (>95 wt % water) to simulate the product. This pallet was then exposed under direct sun light.

### Example 1b

### Comparative Example with Respect to Example 1

Pallet of dimensions described in Example 1 was prepared with only Tyvek® 1048A cover. The above sample showed an air permeability value of 13.7 s per 100 cc of air as measured by Gurley method. Data loggers were placed in boxes as described in Example 1 and the pallets were placed under direct sun light.

Under direct sunlight, FIG. 4 indicates the improved performance of cover used in example 1 over Tyvek® 1048A alone. The product temperatures were nearly 5° C. lower for than Tyvek® 1048A and moreover, time to reach the peak temperature was offset by at least 4 to 5 hours.

### Example 2

A pallet of dimensions described in Example 1 was prepared with a cover of the following layers stitched together (from outside in)—Tyvek® 1048A, 6 mm nitrile rubber foam, and an inner layer of spun bonded Polypropylene (100 g/m² basis weight). The cover showed an air permeability value of 13545 s per 100 cc of air as measured by Gurley method. A thermal resistance of 0.209 m²K/W was obtained using a heat flow meter at 24° C. The pallet was first conditioned at 20° C. for at least 6 hours, before placing it under a shaded region with no direct sun light exposure for at least 3 hours. Data loggers were placed underneath the cover on top of top row middle box and also in top row corner box with 1.7 kgs of gel packs (>95 wt % water) to simulate the product.

### Example 2b

### Comparative Example to Example 2

Pallet of dimensions described in Example 1 was prepared with only Tyvek® 1048A cover. The cover showed an air permeability value of 13.7 s per 100 cc of air as measured by Gurley method. Thermal resistance for this sample could not be measured using a HFM due to sample dimension limitations. However, it is expected to be negligible and near 0 m²K/W.

The pallet was first conditioned at 20° C. for at least 6 hours, before placing it under a shaded region with no direct sun light exposure for at least 3 hours. Data loggers were placed underneath the cover on top of top row middle box and also in top row corner box with 1.7 kgs of gel packs (>95 wt % water) to simulate the product.

FIG. 5 indicates a much slower rate of temperature change for cover used in example 2 over Tyvek® 1048A; there is not more than 5° C. change over 3 hours of exposure while Tyvek® 1048A shows higher temperature values.

### Example 3

A pallet of dimensions described in Example 1 was prepared with a cover of the following layers stitched together—Tyvek® 3563M, 9 mm nitrile rubber foam, and an inner layer of spun bonded Polypropylene (100 g/m² basis weight). The above sample showed an air permeability value of 15000 s per 100 cc of air as measured by Gurley method. A thermal resistance of 0.285 m²K/W was obtained using a heat flow meter at 24° C.

The pallet was exposed to direct sun light for at least 100 hours and the product temperature profiles were recorded using data loggers placed in a top corner box along with 1.7 kgs of gel packs (>95 wt % water) to simulate the product.

### Example 3b

### Comparative Example to Example 3

A Pallet of dimensions described in Example 1 was prepared with only Tyvek® 1048A cover. The above sample showed an air permeability value of 13.7 s per 100 cc of air as measured by Gurley method. Thermal resistance for this sample could not be measured using a HFM due to sample dimension limitations. However, it is expected to be negligible and near 0 m²K/W.

The pallet was exposed to direct sun light for at least 100 hours and the product temperature profiles were recorded, as described in Example 3.

FIG. 6 shows that with a cover as used in Example 3, an average of nearly 8° C. lower peak temperature and a time lag of 5 or more hours are obtained in comparison to Tyvek® 1048A alone.

### Example 4

A 24 cm² sample of a super absorbent polymer (Type 142/52/10, 140 g/m2, Technical Absorbent, UK) was wet with 200 cc of water and made into a panel by completely covering it with stretch wrap. Five such panels were adhered together to create a cover (sans bottom side) for a 250×250×250 mm³ 3-ply corrugated box, over which a Tyvek® 1048A cover was placed and sealed. Data logger was placed inside the box to record temperature. The boxes were exposed to direct sun light for about 50 hours. The above sample showed an air permeability value of >50000 s per 100 cc of air as measured by Gurley method. A thermal resistance of 0.102 m²K/W was obtained using a heat flow meter at 24° C.

### Example 4b

### Comparative Example to Example 4

A 250×250×250 mm³ 3-ply corrugated box was covered with Tyvek® 1048A alone and used as reference. The above sample showed an air permeability value of 13.7 s per 100 cc of air as measured by Gurley method. The boxes were exposed to direct sun light for about 50 hours.

FIG. 7 shows the temperature profiles. The cover described in example 4 shows a slightly lowered temperature and also with a temperature lag of at least 4 hours in comparison to Tyvek® 1048A alone.

### Example 5

20 gel packs were conditioned in a freezer (−17° C.) and arranged along the sides, top, and bottom of a corrugated box containing 900 gm of water at 5° C. (the water pack is used to simulate a perishable temperature sensitive product). This assembly was placed inside the Styrofoam box (with outer dimensions of approximately 50 cm×40 cm×40 cm) to create an atmosphere of low temperature suitable for shipping biopharmaceutical or perishable goods.

A panel consisting of paper skin and a paper honeycomb core of 12″ width, 15 mm height, and wall thickness of 2 mm (Honecore™, Bangalore) was placed inside a bi-axially oriented Polypropylene pouch previously sealed on 3 sides, and a lower atmospheric pressure condition was created. After reduction of air pressure, the open side was thermally sealed without allowing air ingress. Multiples of such panels were then attached through adhesive tape to adequately fit all sides of the Styrofoam box. Over this panel, a composite cover of the following layers stitched together was laid upon the panels and Styrofoam box (‘protected’)—
Tyvek® 1048A outer cover
6 mm Nitrile rubber closed cell foam
20 micron thick laminated Aluminum foil
Spun bonded Polypropylene inner cover

The box was exposed to ambient conditions with an average temperature of 25° C. Data loggers were imbedded in the box to continuously record temperature and this data was analyzed after 100 hours of exposure. The above sample showed an air permeability value of >50000 s per 100 cc of air as measured by Gurley method. A thermal resistance of 0.403 m²K/W was obtained using a heat flow meter at 24° C. for all the layers mentioned, excluding Styrofoam.

### Example 5b

### Comparative Example to Example 5

A Styrofoam box with gel pack and product contents as described in example 5 was prepared without any protective cover. The box was exposed to ambient conditions with an average temperature of 25° C. Data loggers were imbedded in the box to continuously record temperature and this data was analyzed after 100 hours of exposure.

As seen from FIG. 8, substantial differences, greater than 40 hours, were observed between the two boxes at a particular product temperature within the range of 2-20° C.

### Example 6

20 gel packs were conditioned in a freezer (−17° C.) and arranged along the sides, top, and bottom of a corrugated box containing 900 gm of water at 5° C. (the water pack is used to simulate a perishable temperature sensitive product). This assembly was placed inside the Styrofoam box (with outer dimensions of approximately 50 cm×40 cm×40 cm) to create an atmosphere of low temperature suitable for shipping biopharmaceutical or perishable goods.

8 mm, laminated Aluminum foil enclosed, vacuum insulation panels (U-Vacua made by Panasonic®, Japan) with a thermal conductivity of 0.0027 W/m K at 25° C. were placed on all sides of the Styrofoam box and the assembly was placed in a composite cover with the following layers (outer to inner, respectively)—
Tyvek®1048A outer cover
6 mm Nitrile rubber closed cell foam
100 g/m2 spun bonded Polypropylene inner cover

The box was exposed to ambient conditions with an average temperature of 25° C. Data loggers were imbedded in the box to continuously record temperature and this data was analyzed after 100 hours of exposure. The above sample showed an air permeability value of >50000 s per 100 cc of air as measured by Gurley method. A thermal resistance of 3.565 m²K/W was obtained using a heat flow meter at 24° C. for all the layers mentioned, excluding Styrofoam.

### Example 6b

### Comparative Example to Example 6

A Styrofoam box with gel pack and product contents as described in example 6 was prepared without any protective cover. The box was exposed to ambient conditions with an average temperature of 25° C. Data loggers were imbedded in the box to continuously record temperature and this data was analyzed after 100 hours of exposure.

As seen from FIG. 9, substantial differences, greater than 40 hours, were observed between the two boxes at a particular product temperature within the range of 2-20° C.

### Example 7

20 gel packs were conditioned in a freezer (−17° C.) and arranged along the sides, top, and bottom of a corrugated box containing 900 gm of water at 5° C. (the water pack is used to simulate a perishable temperature sensitive product). This assembly was placed inside a 3 mm thick wooden box with outer dimensions of approximately 50 cm×40 cm×40 cm. The wooden box does not contribute to any insulation based on temperature data taken using data loggers on either side of this box.

8 mm, laminated Aluminum foil enclosed, vacuum insulation panels (made by Panasonic® with a thermal conductivity of 0.0027 W/m K at 25° C. were placed on all sides of the wooden box and the assembly was placed in a composite cover with the following layers (outer to inner, respectively)—
Tyvek® 1048A outer cover
6 mm Nitrile rubber closed cell foam
100 g/m2 spun bonded Polypropylene inner cover

The box was exposed to ambient conditions with an average temperature of 25° C. Data loggers were imbedded in the box to continuously record temperature and this data was analyzed after 100 hours of exposure. The above sample showed an air permeability value of >50000 s per 100 cc of air as measured by Gurley method. A thermal resistance of 3.565 m²K/W was obtained using a heat flow meter at 24° C. for all the layers mentioned, excluding wooden box.

### Example 7b

### Comparative Example to Example 7

A Styrofoam box with gel pack and product contents as described in example 6 was prepared without any protective cover. The box was exposed to ambient conditions with an average temperature of 25° C. Data loggers were imbedded in the box to continuously record temperature and this data was analyzed after 100 hours of exposure.

As seen from FIG. 10, a cover as described in example 7 shows lower temperature of about 2-5° C. in comparison to the standard method of shipment described in this example. Styrofoam, which is typically not considered recyclable, can therefore be avoided to still maintain a temperature condition suitable for perishable or biopharmaceutical product.

We claim:

1. A multilayered thermally protective cover for protecting temperature sensitive material, said cover having an outer surface and an inner surface relative to the material and comprising a plurality of layers such that;
an outer layer adjacent to the outer surface is a plexifilamentary web comprising a multiplicity of fibers,
an inner layer adjacent to the inner surface is a nonwoven web,
an internal layer or layers located between the outer and inner layers comprises closed cell polymeric foam;
wherein the protective cover is impermeable to air.

2. The multilayered thermally protective cover as claimed in claim 1, further comprising a layer of connected vacuum panels, each panel having a porous core layer enveloped in a skin layer and at least partially evacuated, and having a metal foil covering that completely envelops the skin layer.

3. The multilayered thermally protective cover as claimed in claim 1 or claim 2 in which the nonwoven web is a spunbond nonwoven of polyolefin.

4. The multilayered thermally protective cover as claimed in claim 3 in which the polyolefin is a polyethylene, polypropylene, polybutene, or a blend or copolymer thereof.

5. The multilayered thermally protective cover as claimed in claim 1 or claim 2 in which the plexifilamentary web is preferably a flash spun polyolefin web.

6. The multilayered thermally protective cover as claimed in claim 1 or claim 2 further comprising a radiative barrier layer located between the nonwoven layer and the foam layer.

7. The multilayered thermally protective cover as claimed in claim 1 or claim 2 further comprising a radiative barrier coating on at least a portion of the fibers of the plexifilamentary web.

8. The multilayered thermally protective cover as claimed in claim 6, wherein the plexifilamentary web has a reflectivity of at least 50% in the wavelength region of 400-700 nm.

9. The multilayered thermally protective cover as claimed in claim 5, wherein the radiative barrier layer has a reflectivity of at least 20% in the wavelength region of 100-3000 nm and an emissivity of at least 0.05.

10. The multilayered thermally protective cover as claimed in claim 5, wherein the radiative barrier layer is selected from a group consisting of metal foils, nonwovens, microporous membranes, perforated sheets, porous cellulosic sheets or combinations thereof.

11. The multilayered thermally protective cover as claimed in claim 1 or claim 2, wherein the foam layer has an R-value of 0.1-13 m2K/W.

12. The multilayered thermally protective cover as claimed in claim 1, wherein the foam layer is selected from the group consisting of nitrile rubber foam, nitrile rubber blended with polyvinyl chloride foam, crosslinked polyethylene foam, polyurethane foam, polystyrene foam, water filled super absorbent polymer or combinations thereof.
